(19) United States
(12) Patent Application Publication
(10) Pub. No.: US 2017/0186082 A1
(43) Pub. Date: Jun. 29, 2017

(54) SYSTEMS AND DEVICES FOR GENERATING AND TRANSMITTING TAILORED MESSAGE DATA USING AN AUTOMATED TELLER MACHINE

(71) Applicant: MASTERCARD INTERNATIONAL INCORPORATED, Purchase, NY (US)

(72) Inventors: Andres Guillermo Lopez, Yonkers, NY (US); Maria Fondeur Butler, New York, NY (US); Birce Arslan, Boston, MA (US); Tyler Welsh, Poway, CA (US); Stephen Parento, White Plains, NY (US)

(73) Assignee: MASTERCARD INTERNATIONAL INCORPORATED, Purchase, NY (US)

(21) Appl. No.: 14/982,101

(22) Filed: Dec. 29, 2015

(51) Int. Cl. G06Q 40/02; H04L 29/08

(52) U.S. Cl. CPC G06Q 40/02; H04L 67/22; H04L 67/12

(57) ABSTRACT

Improved ATMs, and systems including one or more ATMs, are described. A specially configured message module is electrically interconnected to an ATM, thereby enabling the ATM, or ATM system, to generate message data tailored according to ATM users' previous activities/behavior. According to embodiments, systems of the present disclosure may also include an improved payment network enabled to perform some or all of the processes of the message module.

### FIELD OF TECHNOLOGY

The present disclosure relates generally to computing devices, and more particularly to improved automated teller machines.

### BACKGROUND

Individuals routinely use automated teller machines (ATMs) to check account balances, and withdraw and deposit funds. For example, an ATM user may withdraw cash to pay a bill, to send money to a friend or relative, or to shop at a location of the user's choosing.

Yet, ATMs are not beneficial in various respects due to their limited functionality of checking balances, and withdrawing and depositing funds. For example, present ATMs are merely configured to promote cash-based activities.

### SUMMARY

The present disclosure provides an improved ATM, and systems including one or more ATMs, specially configured to generate message data tailored according to a user's previous behavior. The user's behavior is extrapolated from user specific historic transaction activity data. The user's historic transaction activity data is stored within a structured, secure data store that includes activity data of a vast amount of individuals. Thus, the data store may be segmented, as described herein, to allow for easy and efficient isolation of individual-specific activity data.

The present disclosure describes an improved ATM that includes a specially configured message module electrically interconnected to the ATM. The message module has access to user specific historic transaction activity data stored within a structured, secure data store. The message module includes a processor that accesses the user's historic transaction activity data of the ATM user and generates user behavior data determined or extrapolated from the user's historic transaction activity data. The message module processor may be configured to generate score data determined or extrapolated from the user behavior data. The message module processor also selects message data to provide to the user via the ATM user interface, as a function of specific user behavior data, score data or a combination of the user behavior data and user score data.

Systems of the present disclosure also include an improved payment network. In an embodiment, the improved payment network performs some or all of the processes of the message module described above. For example, the improved payment network may include a message module or processor configured to access historic transaction activity data of an ATM user, generate user behavior data extrapolated from the user's historic transaction activity data, generate user score data extrapolated from the user behavior data, and select message data as a function of specific user behavior data, score data or a combination of the user behavior data and user score data.

The improved ATMs and systems of the present disclosure solve the technical problems of present ATMs (i.e., limited functionality that promotes cash based activity) and ATM systems by implementing the message module, which enables improved ATMs and/or payment networks to generate message data tailored to specific ATM users. This technical solution provides an ATM or ATM network based message module specifically implemented to alter functionality of the internal hardware and software components of traditional ATMs and systems.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1A is a block diagram illustrating a system including the improved ATM having a message module generating message data tailored to an ATM user's behavior based on historic activity data according to the present disclosure;

FIG. 1B is a functional block diagram of a message module, according to the disclosure;

FIG. 1C is a flow diagram illustrating accessing of messages from a Look Up Table (LUT) structure in a message data store, according to the disclosure;

FIG. 2 is a block diagram and system flow diagram illustrating an ATM system having a message module generating message data tailored to an ATM user's behavior based on historic activity data, according to the disclosure;

FIG. 3 is a block diagram and system flow diagram illustrating an alternative embodiment of an ATM system having a message module generating message data tailored to an ATM user's behavior based on historic activity data, according to the disclosure;

FIG. 4 illustrates an ATM system overview diagram for an ATM system processing ATM transactions, according to the disclosure; and

FIG. 5 is a process flow diagram illustrating a method for generating message data tailored to an ATM user's behavior based on historic activity data in a system according to the disclosure.

### DETAILED DESCRIPTION

The detailed description of aspects of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment.

The present disclosure generally relates to improved ATMs and systems specially configured with a message module used to generate message data tailored according to data accessed by the message module and relating to an ATM user's previous behavior. The present disclosure provides a message module electrically interconnected to an ATM to enable the ATMs of the present disclosure to generate specially configured message data on the ATM graphical user interface for the user at the time of use. In one embodiment, the message module includes a processor in a specifically structured unit, integrated in the ATM, to overcome the limited functionality and information/data presentation of traditional ATMs and ATM systems. Systems and methods of the present disclosure may also be embodied in an improved payment network that performs some or all of the processes of the message module.

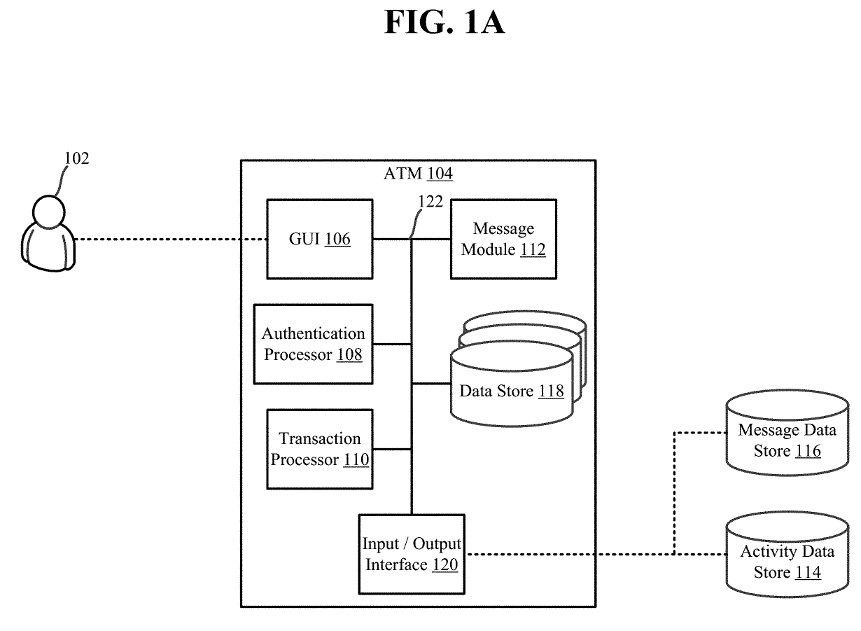

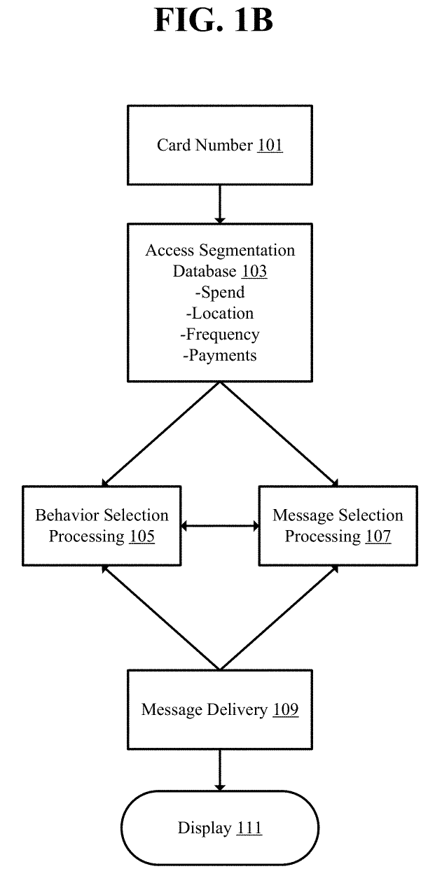

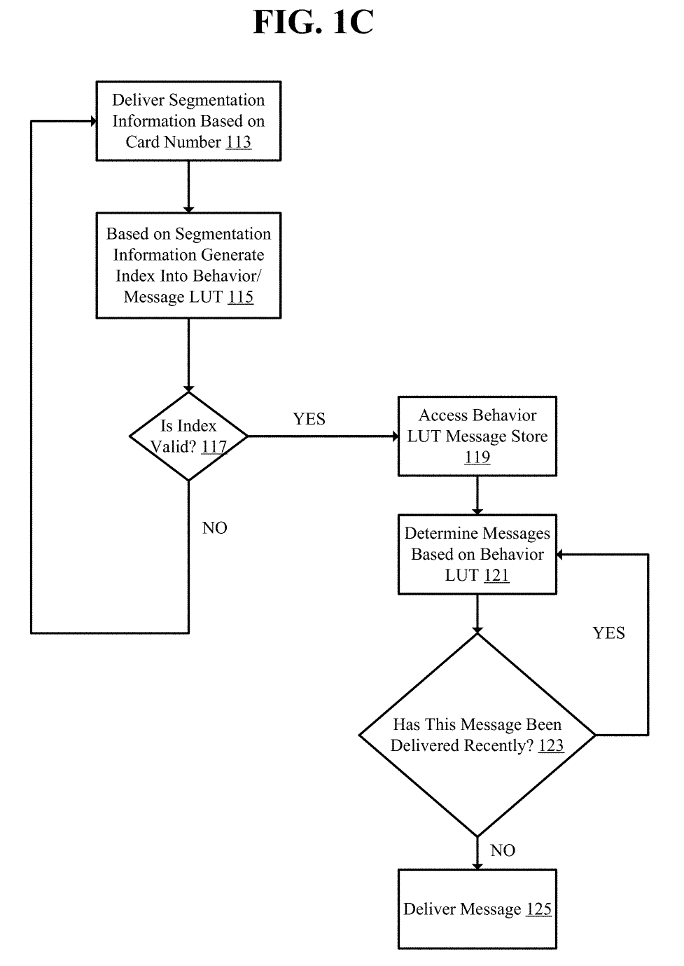

FIG. 1A illustrates a system including an improved ATM for generating and presenting, to an ATM user, message data tailored to the user's previous activity/behavior. Generally, a user 102 presents an ATM 104 with an ATM readable card. An illustrative list of ATM readable cards includes credit cards, debit cards, and credit/debit cards. It should be appreciated that the ATM may also be accessed by a user with other personal transaction devices such as magnetic stripe transport devices, near field communication transaction devices, or other contact or contactless reader payment devices.

The ATM 104 includes a graphical user interface (GUI) 106 configured to receive input from the user 102 and to display content to the user 102. The GUI 106 may contain the components of ATM GUIs known in the art. For example, the GUI may provide the user 102 with the ability to indicate the user desires to deposit funds, the user desires to withdraw cash, and the user desires to check one or more account balances. Upon the user 102 inserting its card into or otherwise accessing the ATM 104, the GUI 106 may solicit a personal identification number (PIN) from the user 102. The ATM 104 may receive input from the user 102 via a keypad and/or a touch screen of GUI 106, or via near field signal communications.

The ATM 104 includes an authentication processor 108 that uses PIN data (corresponding to the PIN of the user) and data from the user's card to authenticate the user 102. Many processes exist in the art regarding ATM user authentication. It should be appreciated that both processes known in the art and those to be invented may be used by the authentication processor 108 to authentication the user 102.

The ATM 104 also includes a transaction processor 110 that executes transactions requested by the user 102. For example, the user 102 may interact with the GUI 106 and indicate a transaction to be performed. The user input is converted into transaction data and communicated to the transaction processor 110. The transaction processor 110 performs the transaction indicated in the transaction data by using account information (read by the ATM 104 from the user's ATM readable card or device) and accessing an institution that maintains the account associated with the ATM readable card.

The ATM 104 additionally includes a message module 112 configured to generate message data tailored according to historic transaction activity to the user 102. The message module 112 is in communication with a secure activity data store 114. Data stored within the activity data store 114 may be associated with a vast amount of individuals. Hence, the activity data store 114 may be configured as (i.e., segmented into) lookup tables that allow the message module 112 to expeditiously isolate or retrieve data specific to the user 102. For example, the activity data store 114 may be segmented on an individual basis (i.e., data corresponding to one individual is structured in a record apart from or selectively linked to data of other individuals). In addition or alternatively, the activity data store 114 may be segmented according to transaction location (i.e., ATM v. point of sale (POS)), amount spent per transaction, balance of accounts associated with ATM readable cards, average transaction amount per individual, and/or transaction amount per transaction location (e.g., per retail establishment, per retail establishment POS), for example.

The message module 112 also communicates with a message data store 116. The message data store 116 includes data corresponding to messages associated with individual behaviors. For example, each message may be associated with a single behavior. Alternatively, a message may be associated with one or more behaviors. For example, some messages may contain content that incentivizes the user 102 to perform card/credit-based transactions at one or more POSs. Other messages may contain content that incentivizes the user 102 to use an application (implemented within a smart device such as a smart phone or tablet), associated with an entity that maintains the ATM 104, to transfer money. Yet other messages may contain content that incentivizes the user 102 to use a bill pay feature of the application associated with the entity that maintains the ATM 104.

The ATM 104 includes one or more data stores 118. The data store(s) 118 may store rules/logic that, when executed by the components (e.g., processors and modules) of the ATM 104, cause the components to perform functions/processes as disclosed herein. Moreover, the ATM 104 includes at least one input/output interface 120 that enables the ATM 104 (and/or components thereof) to communicate data, control signals, data requests, and other information with other devices including computers, data sources, storage devices, and the like. The input/output interface(s) 120 may be configured to communicate via wired or wireless connections. Components of the ATM 104 may be connected via one or more buss(es) 122 and/or direct linkages.

FIG. 1B illustrates a functional block diagram of a message module 112, according to the disclosure. The message module 112 receives or obtains a card number of a transacted ATM readable card (illustrated as 101). The message module 112 uses the card number to access a segmentation database (illustrated as 103). For example, the segmentation database may be segmented based on spend, transaction location, transaction frequency, and payments data. The message module 112 selects a behavior associated with the segmented data using behavior selection processes (illustrated as 105). The message module 112 may also select a message associated with the selected behavior using message selection processes (illustrated as 107). Additionally, the message module 112 configures the selected message for delivery to the ATM user 102 (illustrated as 109), and the message is displayed to the user 102 (illustrated as 111).

FIG. 1C shows an illustrative implementation for accessing messages from a Look Up Table (LUT) structure in a message data store 116, according to the disclosure wherein the message obtained from the message data store (LUT) may be associated with one or more behaviors. Segmentation information based on a card number of a transacted ATM readable card is delivered to either the message module 112 or a payment network 202, which is described in detail herein below (illustrated as 113). The processing component, that receives the segmentation information, generates an index into a behavior/message LUT based on the segmentation information (illustrated as 115). It is then determined whether the index is valid (illustrated as 117) , for example whether the index is appropriate for accessing the LUT. If the index is not valid, for example it is not a value that will provide access to the LUT, additional segmentation information is delivered (illustrated as 113). Alternatively, if the index is determined to be valid, the behavior LUT message store is accessed (illustrated as 119) and messages based on behavior within the LUT are determined (illustrated as 121). Once the appropriate message is selected, it is then determined whether the message has been delivered recently (illustrated as 123). A recent delivery will depend on the circumstances. For example, a recent delivery may be a delivery that occurred within a past week, month, etc. If the message has been delivered recently, another message is determined/selected (illustrated as 121). Conversely, if the message has not been delivered recently, the message is delivered (illustrated as 125).

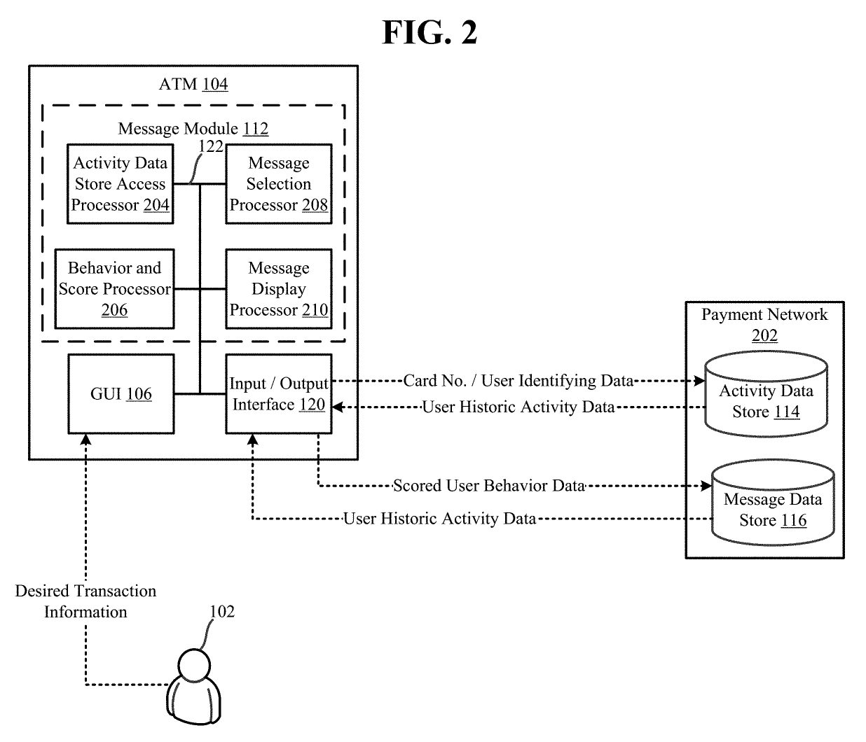

FIG. 2 illustrates a system for generating message data tailored to the ATM user's behavior based on historic activity data. The user 102 interfaces with the ATM 104 with an ATM readable card as discussed hereinbefore. The user provides desired transaction information via the GUI 106. For example, the user 102 may indicate that it wants to withdraw cash, deposit funds, or check a balance of the user's account. In an illustrative embodiment, the ATM 104 reads the ATM readable card to obtain card data. The card data includes content representing card information (e.g., card number, expiration data, card issuer, etc.) and user information (e.g., name, address, etc.).

The message module 112 uses the card data to communicate with a payment network 202 associated with the ATM readable card, and in communication with the ATM 104. The payment network 202 may be an intermediary system involved in processing and settling transactions involving ATM readable cards. As such, for example, the payment network 202 may operate and maintain the activity data store 114, which (as stated above) includes transaction activity data.

In this embodiment, the message module 112 includes an activity data store access processor 204 that communicates with the activity data store 114, thereby giving the message module 112 access to historic transaction activity data of the user 102. As should be understood by one skilled in the art, data stores use various protocols for controlling access thereto. Thus, the activity data store access processor 204 may be configured according to implementation to allow the activity data store access processor 204 to satisfy access protocols of various data stores.

The activity data store access processor 204 uses content of the user's card data to gain access to the activity data store 114. Specifically, for example, the activity data store access processor 204 may gain access to the activity data store 114 using the user's ATM readable card number. Data associated with the user 102 within the activity data store 114 may be segmented according to transaction location (i.e., ATM v. POS), amount spent per transaction, balance of the user's ATM readable card accounts (e.g., when the user has more than 1 ATM readable card), and/or average transaction amount (e.g., per geographic or retail establishment location), for example.

The message module 112 also includes a behavior and score processor 206 that generates behavior data based on the user's historic activity data. The behavior data includes content demonstrating the user's historic transaction conduct. For example, user behavior may be determined according to transaction location (i.e., ATM v. POS), amount spent per transaction, balance of the user's ATM readable card accounts (e.g., when the user has more than 1 ATM readable card), and/or average transaction amount (e.g., per geographic or retail establishment location).

The behavior and score processor 206 also generates score data based on the behavior data. The score data includes content demonstrating how preferred or undesirable the user's transaction behavior is. The score data may contain score information that is determined on a sliding scale. The sliding scale may have a minimum value of one (1) and a maximum value of ten (10), with a value of one (1) corresponding to entirely preferred behavior and a value of ten (10) corresponding to entirely disfavored behavior, or vice versa. However, one skilled in the art should appreciate that the sliding scale may have different minimum and maximum values. For example, if the score behavior includes content correlating to transaction location behavior of the user, a score of one (1) may indicate the user 102 only transacts at an ATM and a score of ten (10) may indicate the user 102 only transacts at merchant POSs.

The message module 112 additionally includes a message selection processor 208 that selects message data corresponding to either the user's behavior data or a combination of the user's behavior data and score data. The message data selected by the message selection processor 208 is stored within the message data store 116. As illustrated, the message data store 116 is operated and maintained by the payment network 202. However, it should be appreciated that the message data store 116 may be operated and maintained by a system, network, or device other than the payment network 202. For example, the message data store 116 may be implemented within the ATM 104 or in a storage network accessible to the ATM.

The data stored within the message data store 116 may include content corresponding to multiple messages. Each message may be associated with at least one indicator. Each indicator may be associated with at least one behavior type. Illustrative behavior types include, for example, a transaction location (i.e., ATM v. POS) type, an amount spent per transaction type, a balance of the user's ATM readable card accounts (e.g., when the user has more than 1 ATM readable card) type, and/or an average transaction amount (e.g., per geographic or retail establishment location) type. In this example, when the indicators are associated with behavior types, message data is selected using the user's behavior data.

Additionally or alternatively, each indicator may be associated with at least one behavior type and at least one score. For example, with respect to the transaction location behavior type, there may be one indicator for every possible score within the message type (e.g., transaction location/score one (1), transaction location/score two (2), transaction location/score three (3), etc.). When the indicators are associated with behavior types and scores, message data is selected using both the user's behavior data and score data.

Message content may be tailored to incentivize specific behaviors. For example, if conducting transactions at a POS is to be incentivized, the message selection processor 208 may be configured to not select message data, from the message data store 116, when the user's behavior data contains transaction location information and the user's score data contains a score of ten (10) (a score of ten (10), according to the example above, indicates the user 102 only transacts at POSs). Alternatively, if the user's behavior data contains transaction location information and the user's score data contains a score of 9 or below (indicating the user 102 engages in transactions at locations other than POSs), the message selection processor 208 may select message data having an indicator associated with the user's behavior, and optionally score data, content.

Once message data is selected by the message selection processor 208, a message display processor 210, of the message module 112, communicates the selected message data to the user 102. The message display processor 210 may communicate the message data to the user 102 as a graphic or text via the GUI 106. Additionally or alternatively, the message display processor 210 may communicate the selected message data to the user 102 as audio via one or more speakers (not illustrated) of the ATM 104.

When the user 102 transacts with the ATM 104, the ATM 104 may solicit, from the user 102, a reason for the transaction via the GUI 106. For example, if the user 102 is withdrawing money, the ATM 104 may solicit reasons for the withdrawal by providing the user 102 with a drop-down menu of various reasons. Some reasons may include pay for a service, send money to a relative or friend, or shopping, for example. In addition to receiving ATM provided reasons, the ATM 104 may also receive user defined reasons. In each instance, the message selection processor 208 may select message data for the user 102 based on the user's behavior data, behavior and score data, as well as the user provided reason for the transaction. For example, if the user indicates the reason is to pay a service, message data corresponding to “If you use your card at a POS, you can get 5% cash back” may be selected. In another example, if the user indicates the reason for the transaction is to send money to a relative or friend, message data corresponding to “Use our smart device application to send money to your friends and family and enter for a chance to win a prize” may be selected. In a further example, if the user indicates the reason for the transaction is for shopping, message data corresponding to “Don't forget that if you use our smart device bill pay application you will get cash back on your next bill” may be selected. Accordingly, the selected message data selected from the message data stored 116 may be selected as a function of the user's behavior data, behavior and score data, as well as the user provided reason for the transaction.

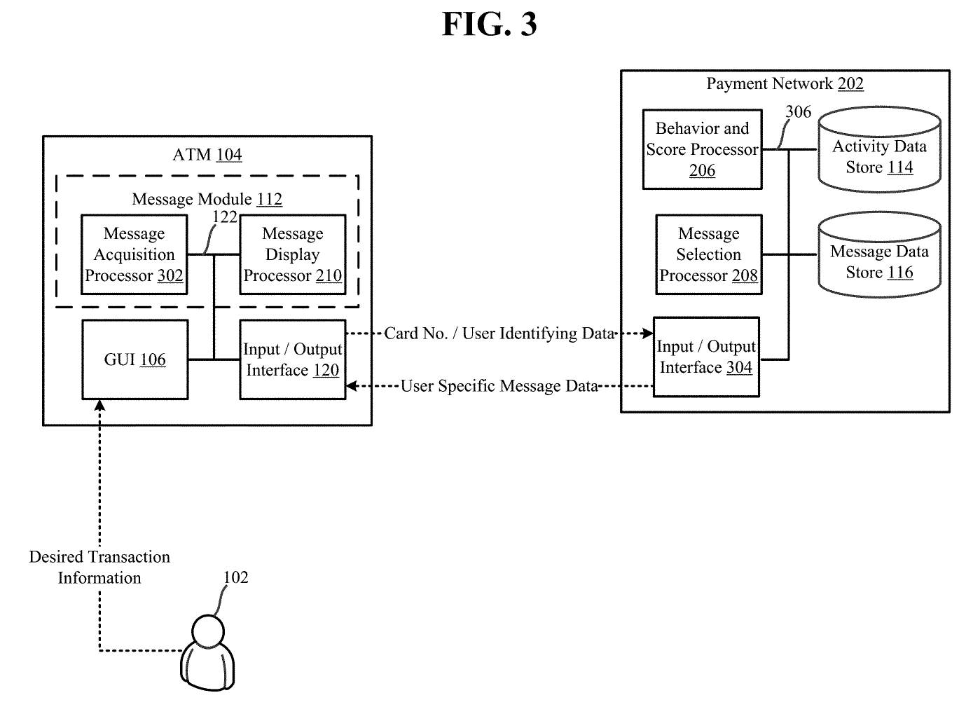

FIG. 3 illustrates an alternative system for generating message data tailored to the ATM user's behavior based on historic activity data. Like FIG. 2, the user 102 of FIG. 3 provides the ATM 104 with an ATM readable card, and desired transaction information via the GUI 106. Desired transaction information may relate to a withdrawal of money, deposit of funds, or the checking of an account balance. A processor or other component of the ATM 104 is configured to read the ATM card or device to obtain card/account data containing content relating to the user 102 (e.g., name, address, etc.) and the card/device (e.g., card number, associated payment network, etc.).

A message acquisition processor 302 of the message module 112 communicates at least some of the card data to the payment network 202. The message acquisition processor 302 identifies the proper payment network to send the card data to, using content of the card data. The payment network 202 includes at least one input/output interface 304 that enables the payment network 202 (and/or components thereof) to communicate data, control signals, data requests, and other information with other devices including computers, data sources, storage devices, and the like. The input/output interface(s) 304 may be configured to communicate via wired or wireless connections. Components of the payment network 202 may be connected via one or more bus(ses) 306 and/or direct linkages.

As illustrated in FIG. 3, the payment network 202 includes the behavior and score processor 206, which generates behavior data and score data as described above with respect to FIG. 2. For example, if the activity data store 114 is structured into look up tables, the behavior and score processor 206 may look up historic transaction activity data specific to the user 102 using the user and card information contained in the card data. Furthermore, according to FIG. 3, the payment network 202 may also include the message selection processor 208, which selects message data as described above with respect to FIG. 2.

The message selection processor 208, or another component of the payment network 202, communicates selected user-specific message data to the message display processor 210, of the ATM's message module 112. The message display processor 210 of FIG. 3 communicates message data to the user 102 similarly or identical to how the message display processor 210 communicates message data as described with reference to FIG. 2 above.

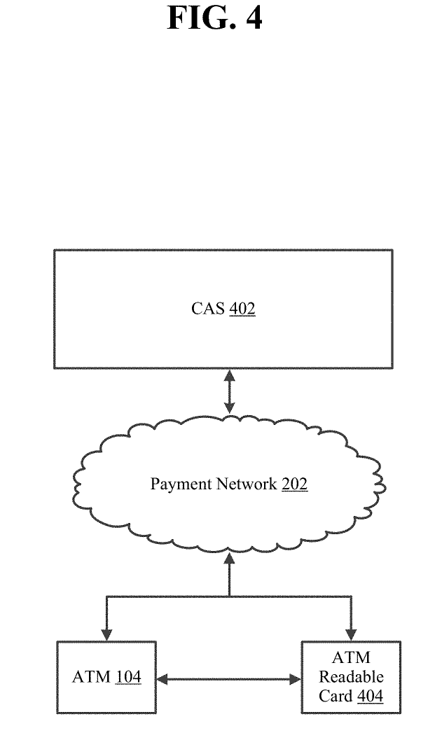

FIG. 4 illustrates a system for processing ATM transactions according to the present disclosure. The system includes a Card Authorization System (“CAS”) 402, the payment network 202, an ATM readable card 404, and the ATM 104. The various system components may communicate via the payment network 202.

The payment network 202 is configured to communicate with various payment acquirers, such as the ATM 104 and point-of-sale (POS) devices and systems (not shown). The payment network 202 also communicates with ATM readable card issuers and cardholders (i.e., the ATM user 102).

The CAS 402 is configured to perform all or part of an authorization process in relation to ATM transactions. The CAS 402 may comprise any combination of hardware and software, such as servers, databases, firewalls, computers, etc., in order to authorize ATM transactions in a secure context. The CAS 402 may be maintained and operated as a part of the payment network 202. For example, the CAS 402 may be implemented within the payment network 202, or the CAS 402 may be operated as a separate system (as illustrated in FIG. 4), operated by the operator of the payment network 202.

The ATM readable card 404 is presented to the ATM 104 to perform an ATM transaction. Transaction data, including transaction information and cardholder account information, is transmitted from the ATM 104 to the payment network 202, which transmits some or all of the transaction data to the CAS 402. The CAS 402 authorizes the transaction using the received transaction data and an account (maintained by the CAS 402) affiliated with the ATM readable card 404. Upon the transaction being authorized, the CAS 402 communicates the authorization to the payment network 202, which communicates the authorization to the ATM 104. The ATM 104, in turn, performs the requested transaction, and is configured in accordance with the disclosure and described, for example, as illustrated in FIG. 1 or 2.

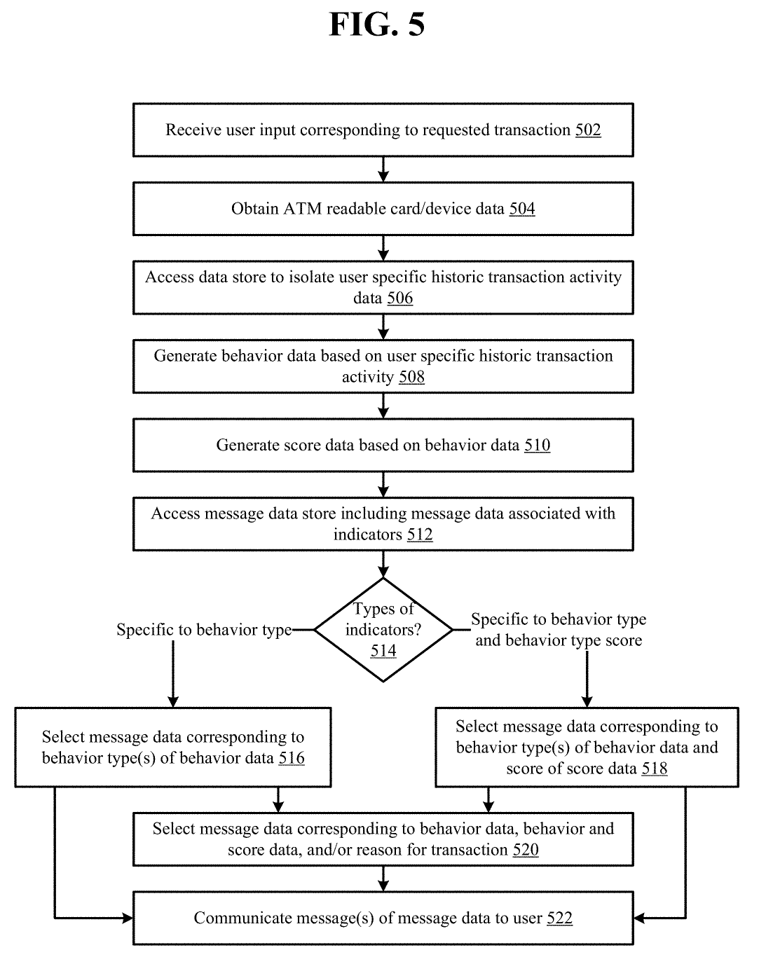

FIG. 5 illustrates a method for generating message data tailored to an ATM user's behavior based on historic activity data. The steps of the method illustrated in FIG. 5 may be performed by components of the ATM 104 and payment network 202 as illustrated in and described with respect to FIGS. 1 through 3 herein.

User input corresponding to requested transaction information (e.g., cash withdrawal, funds deposit, or account balance check) is received (illustrated as 502) and card/account data is obtained from the user's ATM readable card or device (illustrated as 504). The card/device data may contain card/account information (e.g., card/account number, expiration data, card/account issuer, etc.) and user information (name, address, etc.). The card/account data (e.g., card number) is used to access and isolate historic transaction activity of the user (illustrated as 506).

The user specific historic transaction activity data is analyzed to generate behavior data (illustrated as 508). The behavior data may include content specific to one or more types of behavior. An illustrative list of behavior types includes transaction location behavior, spend amount per transaction behavior, account balances behavior, average transaction amount behavior, and transaction characteristics per location behavior. Average transaction amount behavior may be identified on a retail establishment basis, a geographic location basis, etc. Illustrative transaction characteristics include, for example, transaction time, number of items purchased per transaction, and types of items purchased per transaction location.

Score data is generated based on the behavior data (illustrated as 510). For example, a score may be generated for each type of behavior indicated within the behavior data. Each score may be associated with its own score data. Alternatively, score data may contain content corresponding to multiple scores.

The method also includes accessing the message data store that includes message data associated with indicators (illustrated as 512), and the types of indicators present within the message data store are identified (illustrated as 514). If the indicators are specific to behavior type, message data associated with an indicator corresponding to the behavior type of the behavior data is selected (illustrated as 516). Alternatively, if the indicators are specific to behavior type and behavior type score, message data associated with an indicator corresponding to the behavior type of the behavior data and a score of the score data is selected (illustrated as 518).

The method further includes (optionally), selecting message data based on a reason for the ATM transaction (illustrated as 520). For example, message data may be selected solely based on a reason for the transaction. In another example, message data is selected based on behavior data and a reason for the transaction. In yet another example, message data is selected based on behavior data, score data, and a reason for the transaction.

After message data is selected, at least one message corresponding to the selected message data is communicated to the user 102 (illustrated as 522). For example, if the selected message data corresponds to one message, that message is communicated to the user 102. In another example, if the selected message data corresponds to more than one message, one message of the messages is selected and communicated to the user 102. In yet another example, if the selected messaged data corresponds to more than one message, at least two or all of the messages are communicated to the user 102.

Various applications of the disclosed techniques provide substantial improvements to the functioning of automated teller machines (ATMs) and the technical environments in which the ATMs are implemented. Moreover, although the present disclosure has been described herein with reference to the accompanying drawings, it is to be understood that the present disclosure is not limited to those precise teachings, and that various other changes and modifications may be made by one skilled in the art without departing from the spirit and scope of the present disclosure.

What is claimed is:

1. An improved automated teller machine (ATM) comprising:
a graphical user interface (GUI); and
a message module electrically interconnected to the GUI, the message module specially configured to generate message data corresponding to a message tailored to historic transaction activity of a user, comprising:
a behavior and score processor that generates behavior data and score data, the behavior data including behavior content corresponding to historic transaction activity data of a user, the score data including score content corresponding to the behavior content of the behavior data;
a message selection processor that selects message data associated with an indicator, the indicator corresponding to either the behavior content or a combination of the behavior content and score content; and
a message display processor that communicates the selected message data to the user, the message display processor causing the GUI to display the message data as either text or a graphic.

2. The ATM of claim 1, wherein the message module further comprises an activity data store access processor that accesses the historic transaction activity data of the user using one of an ATM readable card number or user identifying data stored on an ATM readable card.

3. The ATM of claim 1, wherein the message selection processor further selects message data associated with the indicator corresponding to a reason for an ATM transaction.

4. The ATM of claim 1, wherein the behavior content of the behavior data includes at least one of transaction location information, amount spent per transaction information, account balance information, average transaction amount information, and transaction amount per transaction location information.

5. An improved automated teller machine (ATM) system, comprising:
an ATM including a graphical user interface (GUI);
a message module electrically interconnected to the ATM, the message module generating behavior data including behavior content based on historic activity data of a user, the message module also generating score data including score content based on the behavior content, the message module also selecting message data based on either the behavior data or a combination of the behavior data and score data, the message module also causing the GUI to display the message data; and
a payment network in communication with the ATM, the payment network including an activity data store housing historic transaction activity data, the payment network further including a message data store housing message data corresponding to messages; the message data being associated with indicators, the indicators corresponding to either behavior content or a combination of behavior content and score content.

6. The system of claim 5, wherein the activity data store is segmented according to user behavior type.

7. The system of claim 6, wherein the user behavior types are selected from the group consisting of transaction location behavior, amount spent per transaction behavior, account balance behavior, average transaction amount behavior, and transaction amount per transaction location behavior.

8. The system of claim 5, wherein the score content is calculated on a sliding scale, the sliding scale having a minimum value and a maximum value, the minimum value corresponding to disfavored behavior and the maximum value corresponding to favored behavior.

9. The system of claim 5, wherein the selected message data corresponds to more than one message, and wherein the message module selects one message of the more than one messages for display by the GUI.

10. The system of claim 5, wherein the selected message data corresponds to more than one message, and wherein the message modules causes the GUI to display at least two messages.

11. The system of claim 5, wherein the GUI is configured to:
display reasons for performing a transaction; and
receive input corresponding to a reason for the transaction, the input corresponding to either a displayed reason or an undisplayed user provided reason.

12. The system of claim 11, wherein the message module selects the message data based on the reason for the transaction.

13. An improved automated teller machine (ATM) system, comprising:
an ATM including a graphical user interface (GUI), the ATM reading an ATM readable card to obtain card data;
a message module electrically interconnected to the ATM, the message module communicating the card data to a payment network, the message module receiving message data from the payment network, the message module causing the GUI to display the message data; and
the payment network in communication with the ATM and the message module, the payment network including data stores housing historic transaction activity data and message data, the payment network referencing the card data against the historic transaction activity data to generate behavior data, the payment network also referencing the behavior data against indicators associated with the message data, the payment network selecting message data associated with an indicator corresponding to the behavior data, and the payment network communicating the selected message data to the message module.

14. The system of claim 13, wherein the payment network references the card data against the historic transaction activity data to isolate historic transaction activity data of a user, the payment network generating the behavior data by identifying a behavior indicated within the historic activity data.

15. The system of claim 13, wherein the payment network generates score data based on the behavior data.

16. The system of claim 15, wherein the payment network references the behavior data and the score data against indicators associated with the message data, and wherein the payment network selects message data associated with an indicator corresponding to the behavior data and the score data.

17. The system of claim 16, wherein each indicator is associated with a range of scores for a particular behavior.

18. The system of claim 13, wherein the payment network selects message data based on a user indicated reason for a transaction.

19. The system of claim 18, wherein the reason for the transaction is either an ATM generated reason or a user generated reason.

20. The system of claim 13, wherein the message data received by the message module corresponds to more than one message, and wherein the message module causes the GUI to display at least one of the more than one messages.
